(19) United States
(12) Patent Application Publication
(10) Pub. No.: US 2006/0233702 A1
(43) Pub. Date: Oct. 19, 2006

(54) Method for oxidative reforming

(76) Inventors: Maxim Lyubovsky, North Haven, CT (US); Subir Roychoudhury, Madison, CT (US)

Correspondence Address: Robert Rispoli;Precision Combustion, Inc., 410 Sackett Point Rd, North Haven, CT, 06473, US

(21) Appl. No.: 11/264,075

(22) Filed: Oct. 31, 2005

Related U.S. Application Data
(62) Division of application No. 10/324,464, filed on Dec. 19, 2002.

(51) Int. Cl. C01B 3/26

(52) U.S. Cl. 423/651

(57) ABSTRACT

A method is taught for oxidatively reforming a fuel that is part of a fuel rich feed stream. The method involves the catalytic partial oxidation of a portion of the fuel followed by the catalytic reforming of a portion of the fuel. The method is conducted within a single catalytic bed wherein the feed stream experiences a generally decreasing mass flux as it passes therethrough. An optional step referred to as equilibration may occur after the conclusion of the catalytic reforming. An apparatus incorporating the method is a catalytic bed wherein the area of the entrance and exit are sized such that partial oxidation and reforming occurs within portions of the catalytic bed and the mass flux of a feed stream therethrough will generally decrease.

### CROSS-REFERENCE

This application is a divisional application of U.S. patent application Ser. No. 10/324,464; filed Dec. 19, 2002, and incorporated herein by reference.

### GOVERNMENT RIGHTS

This invention was developed under contracts with the National Science Foundation, Contract No. 9760946 and the Department of Defense, Contract No. DAAD17-02-CD-0035. The government may have certain rights herein.

### FIELD OF THE INVENTION

The invention is generally directed to a method of operation and design of a catalytic reactor and more specifically to the operation of a catalytic bed useful in the reforming of a fuel.

### BACKGROUND OF THE INVENTION

Numerous chemical processes require a sequence of reactions to convert raw inputs, commonly referred to as a feed stream, into desired outputs. One such chemical process is oxidative reforming, which if conducted in the presence of steam is known as autothermal reforming. Typical oxidative reforming processes chemically convert a fuel into other compounds referred to as products. For example, a fuel such as natural gas may be converted into a product synthesis gas, which can then be further converted into synthetic liquid fuels and other chemicals. Also, a hydrocarbon fuel, such as gasoline, or an alcohol, such as methanol, can be converted such that the hydrogen contained therein is released, thereby permitting the hydrogen to then be used in a fuel cell or other chemical processes. Also, alkanes, such as ethane, can be converted into alkenes, such as ethylene, for further production of polymers and other value added chemicals.

In general, oxidative reforming has two steps with an optional third step. The two steps are referred to as oxidation and reforming while the optional step is refereed to as equilibration. In the oxidation step generally only a portion of the fuel within the reacting stream is consumed leaving some remaining fuel. In the reforming step, reforming reactions convert at least a portion of the remaining fuel into a product, or products. Finally in equilibration, any reactions begun during the first two steps are allowed to complete, thereby allowing the reacting stream to reach thermodynamic equilibrium.

Generally, the oxidative reforming process begins by creating the feed stream including both fuel and oxidant in fuel rich proportions. A feed stream in fuel rich proportions contains more fuel than oxidant as compared to the ratio required for complete combustion of the fuel therein. Under these conditions, all the fuel can never be completely combusted as there is insufficient oxidant present.

In the oxidation step, fuel in the reacting stream is oxidized in fast and exothermic reactions, i.e. releasing heat, which proceed homogeneously in a flame or heterogeneously in the presence of a catalyst. These reactions involve oxidation of at least a portion of the fuel within the feed steam thereby creating oxidation products that are either partial or complete. Where the fuel is a hydrocarbon and the oxidant is oxygen, partial oxidation products may comprise hydrogen and carbon monoxide whereas the complete combustion products are carbon dioxide and water. As another example, in the oxidation of ethane, ethylene would be a partial oxidation product. For equal amounts of fuel, it takes less oxidant to obtain partial oxidation products than to obtain complete oxidation products. Also, generally more heat will be released the greater the amount of complete oxidation products as compared to partial oxidation products formed. Where the feed stream is fuel rich, the oxidation step will complete before all the fuel is converted to partial or complete oxidation products.

Homogeneous reactions, or flame combustion, predominantly produce complete oxidation products. These reactions create excessive amounts of heat generating extremely high temperatures. These temperatures tend to dictate reactor designs and limit the material from which the reactors can be made. Additionally, overall efficiency may suffer if heat loss is not controlled. Finally to stabilize a flame, higher amounts of oxidant than desired for the overall oxidative reforming process may be required.

Unlike homogeneous reactions, heterogeneous oxidation reactions, which occur in the presence of a catalyst, can produce both complete and partial oxidation products. The fraction of partial oxidation products in the total amount of products, usually termed as selectivity, is a function of the amount of time the reacting stream is in the presence of the catalyst (otherwise known as the contact time). As those skilled in the art would appreciate, the partial oxidation products generally result from the oxidation reactions occurring at the contact times on the order of milliseconds.

Reforming reactions, which are endothermic, i.e. heat is required, convert the remaining fuel in the reacting stream into products. Generally, the heat needed to support reforming reactions is obtained from the heat released in the oxidation reactions. Reforming reactions, which occur in the presence of a catalyst, thus are heterogeneous, may include fuel decomposition or fuel recombination with other components added to or produced in the reacting stream, such as steam or carbon dioxide. Reforming reactions are considerably slower than oxidation reactions. Therefore, reforming reactions require longer contact time with the catalyst, which dictate either longer catalytic beds or slower flow rates for the reacting stream. The reforming step concludes when substantially all the fuel in the reacting stream is consumed.

After the reforming reactions conclude, some other ongoing reactions may continue until thermodynamic equilibrium is achieved. This step, known as equilibration, provides the necessary time for completion of these reactions so that the desired components, or products, are maximized. An example of a reaction occurring during equilibration step is a water gas shift reaction, which occurs between carbon monoxide and water following the reforming of a hydrocarbon to yield hydrogen.

Equilibration like reforming is performed in the presence of a catalyst. However, these reactions are slower than the reforming reactions, thus requiring even longer contact times with the catalyst resulting in even longer catalytic beds, or even slower reacting stream flow rates.

Generally, oxidative reforming is performed in a sequence of reactors. Each reactor requires a specific set of conditions, such as temperature and gas mixture composition in order for the reactions to occur as desired. As a result, the reacting stream must be conditioned between the reactors. Additionally, heat must be supplied to the reactor(s) that are performing the reforming reactions. These demands lead to complex system controls and thus expense.

Based on the foregoing, it is the general object of the present invention to overcome or improve upon the problems and drawbacks of the prior art.

### SUMMARY OF THE INVENTION

The invention resides in one aspect in a method for the oxidative reforming of a fuel and in another aspect in an apparatus to use with the method. In the method, a catalytic reactor is provided having a catalytic bed. The catalytic bed is configured such that a reacting stream experiences a generally decreasing local mass flux while passing through the catalytic bed. As used herein a generally decreasing mass flux means that the reacting stream flows in generally diverging directions outward from the entrance, such that the area through which the reacting stream is passing is increasing. As a result, the local mass flux is decreasing.

A catalytic bed particularly well suited for the present invention should allow for equivalent flow of the reacting stream through the catalytic bed in all directions from the point where the feed stream is injected into the bed. In other words, a spherical or radial symmetry of the flow providing generally decreasing local mass flux is preferred. Though, catalytic bed providing other flow geometry with generally decreasing mass flux, such as conical, are also considered within the scope of the invention.

A feed stream including fuel and molecular oxygen, generally as a constituent of air, in fuel rich proportions is then injected into the catalytic bed. Preferably, the relative amounts of molecular oxygen and fuel in the feed stream are such that less than one-half of the fuel can be oxidized to form complete oxidation products. Initial mass flux of the reacting stream at the entrance to the catalytic bed should be sufficiently high such that the selectivity of the oxidation reactions favors partial oxidation products over complete oxidation products. Within the catalytic bed, at least a portion of the fuel is partially oxidized with the molecular oxygen in partial oxidation reactions. Finally, after at least some of the molecular oxygen is consumed in the partial oxidation reactions at least a portion of the fuel is reformed in reforming reactions.

The reforming step begins sometime after a portion of the molecular oxygen is consumed. As the oxidative reforming process occurs within a single catalytic bed, the reforming reactions may be concurrent with a portion of the oxidation reactions, that is occur within the same region of the catalytic reactor. The reforming reactions may also continue sometime after the conclusion of the oxidation reactions, i.e. the point at which substantially all the molecular oxygen is consumed. The reforming reactions are generally allowed to continue until substantially all the fuel is reformed.

As an optional step, equilibration may be permitted. It is understood that equilibration reactions are occurring during the reforming reactions. However, as the reforming reactions conclude when substantially all the fuel is consumed, the reacting stream may not yet reach thermodynamic equilibrium, such that the desired product, or products, may not be achieved, or maximized. Equilibration step provides the time needed for equilibration reactions to complete after the conclusion of the reforming reactions.

The invention resides in another aspect in an apparatus for performing the oxidative reforming method discussed above. The apparatus includes a catalytic bed having a geometry such that the mass flux of a reacting stream passing through the catalytic bed generally decreases. The catalytic bed is suitable for supporting oxidation, reforming, and optionally equilibration reactions. The particular catalyst is application dependent based on the components of the feed stream, such as fuel and oxidant. The catalyst can be uniform throughout the catalytic bed or graded based on the specific reactions contemplated at specific locations within the catalytic bed.

The area of the entrance to the catalytic bed should be sufficiently small such the initial mass flux is sufficiently high to favor the creation of partial oxidation products in the initial part of the catalytic bed. The area of the exit should be sufficiently large such that the final mass flux is sufficiently low to permit reforming and equilibration to reach the desired level of completion. The rate of the oxidation reactions is at least 2 or more times the rate of the reactions occurring during reforming and equilibration. Thus, to maximize the product, or products from the oxidation reforming process, it is preferred that the mass flux of the feed stream at the entrance to the catalytic bed be at least two times greater than the mass flux of the reacting stream at the exit of the catalytic bed. Therefore, it is preferred that the exit area of the catalytic bed be at least two times larger than the entrance area.

### BRIEF DESCRIPTION OF THE DRAWINGS

FIG. 1 is a cross sectional view of a spherical catalytic reactor taken along the diameter.

FIG. 2 is a perspective side view of a cylindrical radial flow catalytic reactor.

FIG. 3 is a graph of test results depicting radial position within a cylindrical catalytic bed versus composition and temperature of the reacting stream therein.

### DETAILED DESCRIPTION OF THE PREFERRED EMBODIMENTS

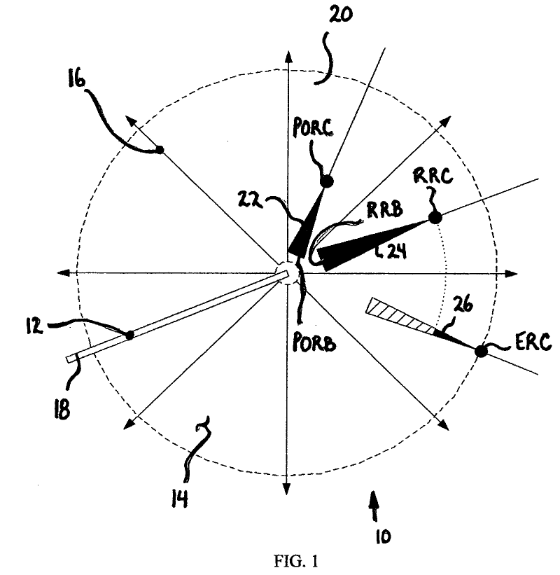

As shown in FIG. 1, in a spherical catalytic reactor, generally denoted by the reference number 10, a feed stream 12 in fuel rich proportions, which is, the feed stream has more fuel than air based on a complete combustion reaction, is introduced into the center of a catalytic bed 14 and flows radially outward through the catalytic bed 14, as a reacting stream depicted by flow arrows 16.

As the reacting stream 16 is flowing radially outward within a spherically shaped catalytic bed 14, the mass flux of the reacting stream is continually decreasing. Mass flux is a measure of how much mass is passing through a given area per unit time and per unit area in the direction perpendicular to the area. As depicted, the feed stream 12 enters the catalytic bed 14 through a tube 18. As the tube 18 has a constant cross section, the mass flux of the feed stream 12 within the tube is constant. If the diameter of the tube 18 were increasing in the direction of flow of the feed stream 12, the mass flux of the feed stream would be decreasing. If the cross section were decreasing, the mass flux of the feed stream would be increasing.

Mass flow can be determined for any area, therefore the feed stream 12 has a quantifiable mass flow upon exiting the tube 12. Since the catalytic bed 14 is spherical, this entering mass flow provides the maximum mass flux for the reacting stream 16 within the catalytic bed. While the total mass flow through the catalytic bed 14 does not change, the mass flux is constantly decreasing as the surface extending radially outward from the center of the spherical catalytic bed 14 is constantly increasing. Thus, the geometric structure of the catalytic bed 14 assures a constantly decreasing mass flux of the reacting stream 16.

The reacting stream 16 interacts with a catalyst 20 within the catalytic bed 14, to first perform oxidation reactions 22, then reforming reactions 24 and finally to support concluding thermodynamic equilibration reactions 26. The oxidation reactions 22 are exothermic releasing heat into the catalytic bed 14, which is transmitted by various mechanisms, such as convection and conduction, throughout the catalytic bed 14. The oxidation reactions, which can produce complete or partial oxidation products, begin almost instantaneously after the feed stream 12 enters the catalytic bed 14, denoted by the point Partial Oxidation Reaction Begin (“PORB”) in FIG. 1, and continue until substantially all the initial oxidant (molecular oxygen in air) in the reacting stream 16 is consumed, denoted by the point Partial Oxidation Reaction Complete (“PORC”) in FIG. 1. As stated above, the feed stream 12 is in fuel rich proportions. This means that it is impossible to combust all the fuel in oxidation reactions. As such, some amount of fuel will be present both during and after the oxidation reactions for reforming.

Generally, the reforming reactions 24 will begin prior to the completion of the oxidation reactions 22, as denoted by the point Reforming Reaction Begin (“RRB”). These reactions may include fuel decomposition and fuel recombination with other components of the reacting stream and continue until substantially all the entering fuel is reformed, as denoted by the point Reforming Reaction Complete (“RRC”). At this point, however, thermodynamic equilibrium may not have being reached. Thus, there may be an additional equilibration step 26, which commences at point RRC and ends when desired, or at completion of all the thermodynamic equilibration reactions, designated by the point Equilibration Reaction Complete (“ERC”). In the present example, the point at which thermodynamic equilibrium is achieved (ERC) is coincident with the exterior surface of the catalytic bed 14.

The initial mass flux of the reacting stream at the entrance to the catalytic bed 14 should be sufficiently high such that the selectivity of the oxidation reactions favors partial oxidation products over complete oxidation products. It is preferred that reacting flow residence time on the oxidation step is on the order of milliseconds. Maximizing partial oxidation products in the oxidation step increases the amount of fuel converted in fast oxidation reactions while minimizing the temperature and heat loss. Lower temperatures increase the overall efficiency of the process and allow for greater selection of materials from which to make the catalytic reactor.

The reforming step 24 and equilibration step 26 occur at mass flux significantly below the mass flux preferred for partial oxidation step 22. Preferably, to accomplish the changes in mass flux required through the catalytic bed 14, the exit area of catalytic bed should be larger than the entering area by at least a factor of two.

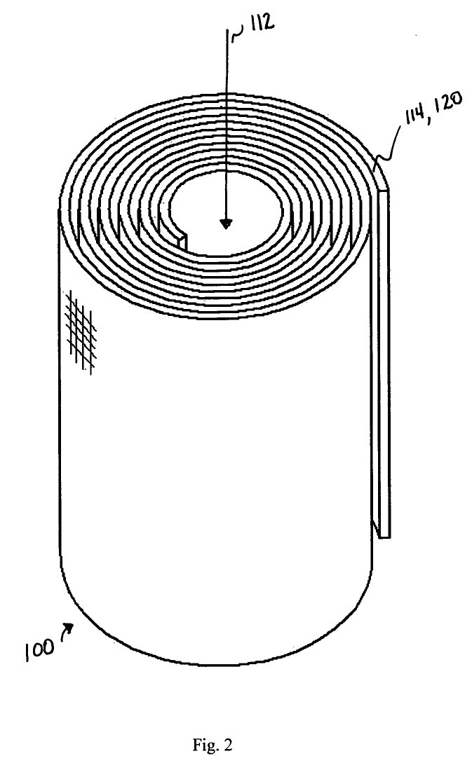

FIG. 2 depicts a cylindrical catalytic reactor bed suitable for the present method. The cylindrical catalytic reactor bed is similar in many respects to the previously discussed spherical catalytic bed therefore like elements will be given the same reference number preceded by the number 1. The cylindrical catalytic reactor, generally denoted by the reference number 100, has a catalytic bed 114. In a preferred embodiment the catalytic bed is made by winding a metallic Microlith® (ultra-short channel length substrate) screen available from Precision Combustion, Inc of North Haven, Conn., about an axis, thereby forming a cylinder. The catalytic bed 114 has positioned at the surface thereof a catalyst 120 comprised of a ceramic wash coat and metal of Group VIII of the periodic table of elements, suitable for the desired partial oxidation and reforming reactions. The catalyst 120 can either be the same or different throughout the catalytic bed 114. Feed stream 112 is injected along the axis of the cylindrical catalytic bed 114, and flows radially therethrough.

### EXAMPLE 1

The reforming of methane to syngas was performed using a cylindrical catalytic reactor. The reactor was constructed from a Microlith® (ultra-short channel length substrate) screen coated with La-stabilized alumina washcoat and Rh catalyst. The reactor was 3 inches long with an inside diameter of 0.125 inches and an outside diameter of 0.4 inches. A methane/air stream in fuel rich proportions, a stoichiometric fuel/air equivalence ratio of 3.5, was passed into the inside passage. The volumetric flow rate entering the inside passage was 6 Standard Liters Per Minute (“SLPM”). Analysis of the reformate stream exiting the catalytic reactor indicated that 90% of the methane was converted with above 90% product selectivity to carbon monoxide and hydrogen.

### EXAMPLE 2

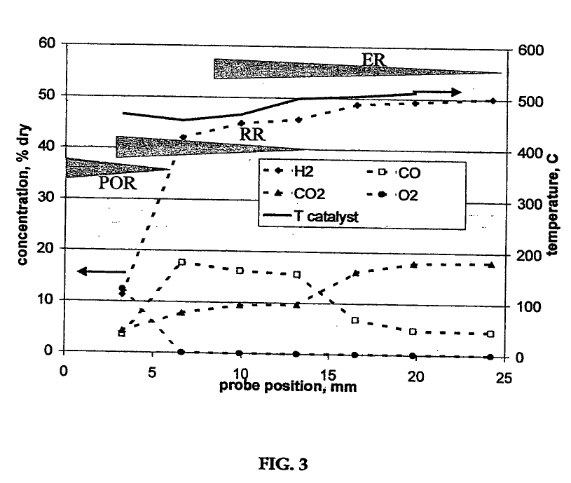

Using a catalytic reactor similar to that above, a feed stream of prevaporized methanol with steam and air was used. The catalytic reactor had 110 layers and was 2 inches long with an inside diameter of 0.137 inches and an outside diameter of 2 inches. The reactor was constructed from a Microlith® (ultra-short channel length substrate) screen coated with La-stabilized alumina washcoat and Pt catalyst. The feed stream was in the molar ratio of 1/2/1.4 (oxygen plus nitrogen). The feed stream was fed into the inside passage at the total rate of 50 SLPM at a temperature of 200 degrees C. Analysis of the reforming stream disclosed a gas composition (dry) of approximately 52% hydrogen, approximately 19% carbon dioxide, and approximately 4.5% carbon monoxide with the balance being nitrogen. This corresponds to 100% conversion of the methanol and a hydrogen yield of about 450 cc/sec (27 SLPM). The radial temperature and reacting mixture composition profiles are depicted in FIG. 3. Approximate beginning and completion of the Partial Oxidation Reaction (“POR”), Reforming Reaction (“RR”) and Equilibration Reaction (“ER”) steps are depicted by the arrows labeled correspondingly POR, RR and ER.

### EXAMPLE 3

Using the same reactor as that in Example 2, a prevaporized methanol/steam/air mixture in the molar ratio of 1/2/1.6 (oxygen plus nitrogen) was fed into the inside passage at the total rate of approximately 5 SLPM and a temperature of approximately 200 degrees C. The composition of the exiting reformate (dry) was approximately 50% hydrogen, approximately 21% carbon dioxide, approximately 1.3% carbon monoxide, 0.5% methane with the balance being nitrogen. This corresponds to 100% conversion of the methanol and a hydrogen yield of approximately 45 cc/sec (2.66 SLPM).

### EXAMPLE 4

Using a catalytic reactor similar to that above, a feed stream of prevaporized 2,2,4-trimethylpentane (isooctane) with steam and air was used. The catalytic reactor had 45 layers and was 2 inches long with an inside diameter of 0.137 inches and an outside diameter of 1 inch. The reactor was constructed from a Microlith® (ultra-short channel length substrate) screen coated with La-stabilized alumina washcoat and Pt catalyst. The feed stream was in the molar ratio of 1/0.45/2.2 (oxygen plus nitrogen). The feed stream was fed into the inside passage at the total rate of 15 SLPM at a temperature of 450 degrees C. Analysis of the reforming stream disclosed a gas composition (dry) of approximately 34% hydrogen, approximately 3.3% carbon dioxide, and approximately 21% carbon monoxide with the balance being nitrogen. Complete conversion of the isooctane was achieved.

Although the present invention has been described in considerable detail with reference to certain preferred versions thereof, other versions are possible. Therefore, the spirit and scope of the invention should not be limited to the description of the preferred versions contained herein.

The invention claimed is:

1. A method for the oxidative reforming of a fuel comprising the steps of:
a) providing a catalytic reactor having a catalytic bed therein, the catalytic bed being configured so that a reacting stream passing through the catalytic bed experiences a generally decreasing mass flux;
b) injecting the feed stream comprising fuel and molecular oxygen in fuel rich proportions into the catalytic bed;
c) oxidizing at least a portion of the fuel with the molecular oxygen creating partial oxidation products; and
d) reforming at least a portion of the fuel after at least a portion of the molecular oxygen has been consumed.

2. The method of claim 1 wherein in the oxidation step substantially all the molecular oxygen is consumed.

3. The method of claim 1 wherein in the reforming step substantially all the fuel is reformed.

4. The method of claim 1 wherein after the step of reforming the method includes the further step of reaching thermodynamic equilibrium for the reacting stream.

5. The method of claim 1 wherein the fuel comprises a hydrocarbon or alcohol.

6. A method for oxidative reforming comprising the steps of passing a feed stream comprising fuel and molecular oxygen in fuel rich proportions through a catalytic bed suitable for supporting partial oxidation reactions and reforming reactions and wherein the mass flux of the reacting stream generally decreases as it passes through the catalytic bed and initial mass flux being sufficiently high to permit the partial oxidation reactions to occur.

7. The method of claim 6 wherein the fuel rich proportions are such that less than one-half of the fuel would be oxidized in a complete oxidation reaction.

8. The method of claim 7 wherein the feed steam comprises a hydrocarbon or alcohol.

9. The method of claim 7 wherein the feed stream comprises steam.

10. The method of claim 7 wherein the feed stream comprises carbon dioxide.

11. The method of claim 7 wherein the feed stream comprises at least two fuels.

12. A method for chemically converting an input into an output comprising:
a) providing a catalytic reactor having a catalytic bed therein with at least one catalyst deposited thereon, the catalytic bed being configured so that a flow stream passing through the catalytic bed experiences a generally decreasing mass flux;
b) introducing a feed stream into the catalytic bed wherein the feed stream experiences a generally decreasing mass flux;
c) forming a reacting stream flowing through a first portion of the catalytic bed wherein the reacting stream experiences a generally decreasing mass flux; and
d) reforming the reacting stream flowing through a second portion of the catalytic bed wherein the reformed reacting stream experiences a generally decreasing mass flux.

13. The method of claim 12 including an additional step of achieving thermodynamic equilibrium of the reformed reacting stream exiting the catalytic bed.

14. The method of claim 12 wherein the step of forming the reacting stream is an exothermic reaction, the method including an additional step of transmitting the heat generated by the exothermic reaction downstream of the forming reaction.
